(19) United States
(12) Patent Application Publication
(10) Pub. No.: US 2008/0099308 A1
(43) Pub. Date: May 1, 2008

(54) METHOD AND APPARATUS FOR REGULATING SIGNATURE HANDLING TO COMPENSATE FOR CHAIN ELONGATION

(75) Inventor: David F. Hall, Plattsburgh, NY (US)

Correspondence Address: John Pietrangelo;HESLIN ROTHENBERG FARLEY & MESITI, P.C., 5 Columbia Circle, Albany, NY, 12203, US

(73) Assignee: PRIM HALL ENTERPRISES INC., Plattsburgh, NY (US)

(21) Appl. No.: 11/554,767

(22) Filed: Oct. 31, 2006

(51) Int. Cl. B65G 43/08

(52) U.S. Cl. 198/464.3

(57) ABSTRACT

Methods and systems are provided for regulating the operation of a chain driven conveyor to minimize the effect of chain stretch. The system includes a chain conveyor having a chain and a plurality of indexing pins mounted to the chain, a signature feeder, at least one sensor adapted to detect variations in chain length; and a controller adapted to control the speed of rotation of the signature feeder in response to the variations in chain length to minimize variations in the spacing of the signatures and the indexing pins. The signature feeder may include a disk separator and a drum conveyor or a crank-type conveyor, among others. Methods of operating the system are also disclosed.

### TECHNICAL FIELD

The present invention relates to sheet material handling systems and methods, and more particularly to systems and methods for controlling the operation of sheet material feeding systems in response to variations or stretch in conveyor chains of conveyors to which the sheet material is fed.

### BACKGROUND OF THE INVENTION

The binding and printing industries often rely on high-speed sheet material handling systems for printing, collating, binding, and otherwise handling sheet material, for example, sheets of paper. This sheet material, for example, individual sheets, newspapers, magazines, inserts and “onserts” (that is, sheet material used when collating newspapers), free-standing inserts (FSIs), books, brochures, and the like, is typically, fed to and accumulated in containers or “magazines” or “hoppers” and withdrawn from the magazines or hoppers for further processing. One particular sheet material that is handled in the binding and printing industry is what is known in the art as a “signature.” A signature typically comprises two or more sheets of paper that may be folded to form a spine, that is, a “spine fold.” Signatures may contain four or more pages of text or graphics, for example, 30 or more pages of text or graphics.

In the manufacture of books or the assemblage of newsprint, it is common to assemble the book on a collecting conveyor by sequentially withdrawing signatures from magazines, or hoppers, containing stacks of signatures. In producing a book, typically, a plurality of serially arranged hoppers, separating devices, and feeders are employed for gathering and collating the printed sheets of, for example, signatures. Typically, the separating devices separate and withdraw the sheet material from the hoppers and feed the sheet material to a rotating drum. The rotating drum then feeds the sheet material to a conveyor that collects and transfers the separated printed sheets for collation, binding, or other handling. The separation of the sheet material from the stacked sheet material is typically effected by a rotating disk separator. One typical disk-type separator is disclosed in U.S. Pat. No. 6,193,229 B1, the disclosure of which is incorporated by reference herein in its entirety. The disk separator separates and feeds the sheet material to a rotating drum that accepts and retains the sheet material and conveys it to the conveyor. The conveyor that receives the sheet material is typically a horizontal conveyor. This horizontal conveyor may also receive sheet material from other, typically serially positioned, feeding drums.

These collating conveyors are typically driven by a drive chain, for example, a link-type chain mounted on sprockets and driven by a drive motor. The drive chain typically includes a plurality of posts, “pusher pins,” or “indexing pins” that provide reference locations for positioning signatures and may also contact or push the signatures along the conveyor. The relative spacing of the signatures with respect to the chain pins, especially when multiple signatures are stacked on the conveyor, is often critical to the assembly of uniform stacks of signatures that are forwarded to further processing, for example, to a binder. However, variation in drive chain length, or “chain stretch,” can occur due to chain wear or deformation whereby the relative location of the pusher pins may vary. Since the placement of signatures on the conveyor by the feed drum is typically synchronized with the movement of the drive chain, any variation in the relative spacing of the pusher pins can interfere with the desired placement of the signatures. This is particularly true as the length of drive chain conveyors increases to accommodate desired higher capacities.

Attempts have been made in the prior art to address the problem of chain stretch. For example, U.S. Pat. No. 6,328,297 (herein, “the '297 patent”) discloses a chain driven conveyor system that is fed by a series of document feeders. The system described in the '297 patent includes two sensors and a control system adapted to compensate for chain stretch by regulating the actuation of the document feeders. However, the '297 patent assumes that chain stretch is linear throughout the conveying chain. However, the present inventor has found that chain stretch is typically not linear, and assuming a linear variation in chain stretch can provide less than optimum performance. Aspects of the present invention overcome this and other disadvantages of the '297 patent.

U.S. Pat. No. 6,851,546 (herein, “the '546 patent”) also discloses a system to detect “chain stretch.” The '546 patent discloses a system that includes two sensors which detect markers on a chain. When the sensors detect changes in sensor triggering due to chain wear/elongation, the sensors are simply moved to reestablish the desired simultaneous triggering. This system of the '546 patent is also inadequate to application to high-speed production conveyors that are not conducive to continuously varying the placement of sensors. Aspects of the present invention overcome this and other disadvantages of the '546 patent.

### SUMMARY OF THE INVENTION

The present invention and its many aspects as described in detail provide systems and methods for optimizing the operation and performance of chain driven collators. Aspects of the invention address many of the disadvantageous of the prior art and provide potential for dramatic improvement in collator operation. One aspect of the invention is a method for feeding signatures to a chain conveyor, the chain conveyor having a chain and a plurality of indexing pins mounted to the chain, the method including activating the chain conveyor; transferring the signatures to the chain conveyor wherein each signature is spaced from at least one of the indexing pins on the chain conveyor; detecting a variation in chain length for a plurality, for example, each, of the indexing pins of the chain conveyor; and controlling the transfer of signatures to the chain conveyor in response to the variations in chain length to minimize variations in the spacing of the signatures and the indexing pins. In one aspect, transferring the signatures to the chain conveyor is practiced using a signature feeder adapted to transfer signatures from a supply of signatures to the chain conveyor, the signature feeder having a variable speed motor adapted to provide the motive force to transfer the signatures to the chain conveyor, and wherein controlling the transfer of signatures to the chain conveyor comprises controlling the speed of the variable speed motor. In another aspect, transferring the signatures to the chain conveyor is practiced using a disk separator adapted to transfer signatures from a supply of signatures and a drum conveyor adapted to receive signatures from the disk separator and transfer the signatures to the chain conveyor, and wherein controlling the transfer of signatures to the chain conveyor comprises controlling the operation of at least one of the disk conveyor and the drum conveyor.

Another aspect of the invention is a system for feeding signatures to a chain conveyor having a chain and a plurality of indexing pins mounted to the chain, the system including a signature feeder adapted to transfer signatures from a supply of signatures to the chain conveyor, the signature feeder having at least one variable speed motor adapted to provide the motive force to transfer the signatures to the chain conveyor; at least one sensor adapted to detect a variation in chain length for a plurality, for example, each, of the indexing pins of the chain conveyor; and a controller adapted to control the at least one variable speed motor in response to the variation in chain length to minimize variations in the spacing of the signatures and the indexing pins. In one aspect, the signature feeder comprises a disk separator adapted to transfer signatures from a supply of signatures; and a drum conveyor adapted to receive signatures from the disk separator and transfer the signatures to the chain conveyor. In another aspect, the signature feeder comprises a crank feeder.

A further aspect of the invention is a system for assembling signatures including a collator having a chain conveyor, the chain conveyor having a chain and a plurality of indexing pins mounted to the chain; a disk separator adapted to transfer signatures from a supply of signatures; a drum conveyor adapted to receive signatures from the disk separator and transfer the signatures to the collator wherein each signature is spaced from at least one of the indexing pins; at least one variable speed motor adapted to rotate at least one of the disk separator and the drum conveyor; at least one sensor adapted to detect a variation in chain length for a plurality, for example, each, of the indexing pins of the chain conveyor; and a controller adapted to regulate operation of the at least one variable speed motor to vary speed of at least one of the disk separator and the drum conveyor in response to the variation in chain length to minimize misalignment of signature placement relative to the indexing pins. In one aspect, the at least one sensor comprises a plurality of spaced sensors. In another aspect, the plurality of spaced sensors comprise a plurality of sensors adapted to detect the indexing pins.

These and other aspects, features, and advantages of this invention will become apparent from the following detailed description of the various aspects of the invention taken in conjunction with the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention will be readily understood from the following detailed description of aspects of the invention taken in conjunction with the accompanying drawings in which:

FIG. 1 side elevation view of conveyer system having aspects of the present invention.

FIG. 2 is a side view of a signature feeder that may be used in the conveying system shown in FIG. 1.

FIG. 3 is a plan view of a typical section of a conveyor chain according to one aspect of the invention.

FIG. 4 is an elevation view of the section of the conveyor chain shown in FIG. 3.

FIG. 5 is a perspective view of a pusher pin that can be mounted to the conveyor chain shown in shown in FIG. 3.

FIG. 6 is a schematic illustration of a control system according to one aspect of the invention for use in the conveying system shown in FIG. 1.

FIG. 7 is a profile of typical chain stretch that can be accommodated according to aspects of the present invention.

### DETAILED DESCRIPTION OF THE INVENTION

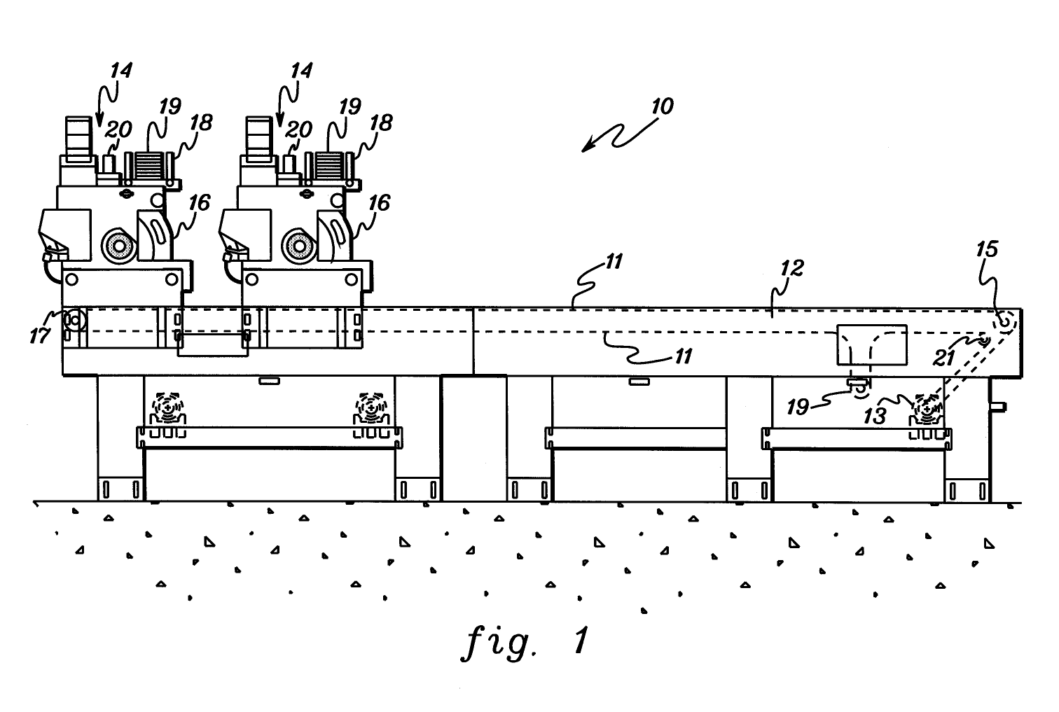

FIG. 1 side elevation view of conveyer system 10 incorporating aspects of the present invention. Though the following discussion will use the term “signature” almost exclusively when referring to the sheet material being handled, it will be understood by those of skill in the art that aspects of the invention may be applied to the handling of any sheet material, including, but not limited to, individual sheets, newspapers, magazines, inserts, onserts, FSIs, books, brochures, packages, and the like.

Conveyer system 10 in FIG. 1 includes a conveyer 12, and a number of signature feeders 14. Each signature feeder 14 includes a rotatable feed drum 16, stacked signatures in hopper 18, and a separator disk servomotor 20. As is known in the art, the feeder 14 separates signatures from the hopper 18. Though the following discussion of embodiments of the invention will reference the invention's application to feeding systems having a disk separator and a drum conveyor, it will be understood by those of skill in the art that aspects of the invention may be applied to any conventional signature conveying or feeding device. For example, instead of disk separator and drum feeder, aspects of the invention may be used with a “shuttle-type” or a “crank-type” feeder, for example, a feeder having pusher or shuttle adapted to feed signatures to a conveyor from a supply of signatures. Such feeders may typically be driven by a variable speed motor whereby the feeding rate may be varied by regulating the speed of the motor. In one aspect, the feeding device may be a crank type feeder sold by Prim Hall of Plattsburgh, N.Y. under the name “FSI Thick Product Hopper Feeder,” as illustrated in Prim Hall drawings AB53676 and AB53669 (the disclosures of which are incorporated by reference herein), or its equivalent.

In one aspect, conveyer 12 is positioned with respect to the feed drums 16 for receiving signatures from hopper 18 from feed drum 16. Feed drum 16 rotates and delivers signatures, one at a time, to conveyer 12. Conveyer 12, in accordance with one aspect of the invention, functions to gather signatures 18, for example, gather stacks of signatures. Conveyer system 10 typically includes a plurality of feeders 14 whereby conveyer 12 gathers and collates signatures for forwarding to, for example, a binding machine, for further processing.

According to aspects of the invention, conveyor 12 typically includes a conveyor chain 11 that conveys the signatures whereby the signatures are transferred to the desired destination, for example, to a binding machine. Chain 11 is typically driven by one or more sprocketed chain drive motors 13 and chain 11 is passed over two or more sprockets, for example, sprockets 15, 17, 19, and 21, to position chain 11 as desired in conveyor 12.

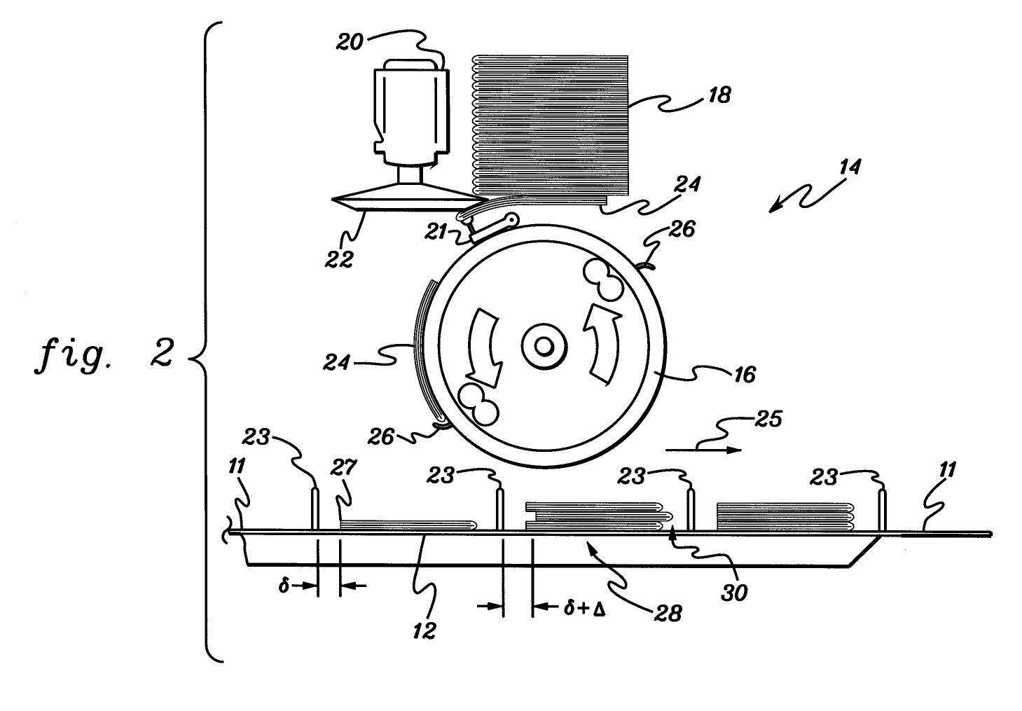

FIG. 2 is a side view of a signature feeder 14 shown in FIG. 1 that may be used in the conveying system shown in FIG. 1. As shown in FIG. 2, feeder 14 includes a means 21 for separating individual signatures 24 from the stack of signatures in hopper 18, for example, a “sucker arm,” and a rotatable separator disk, or disk separator, 22. Separator disk 22 is mechanically driven by variable speed motor or servomotor 20. Servomotor 20 typically rotates separator disk 22 at a variable speed to separate individual signatures 24 from the stacked signatures in hopper 18 and deliver the separated signatures 24 to the conveyer 12.

As is conventional, for example, as described in U.S. Pat. No. 6,193,229 (the disclosure of which is incorporated by reference herein), when separator disk 22 rotates to separate a signature 24 from the stacked signatures from hopper 18, the sucker arm 21 employs a vacuum to draw one end of the separated signature 24 from separator disk 22 and position the end of the signature 24 on or adjacent to feed drum 16. Feed drum 16 is typically driven by a servomotor (not shown). Feed drum 16 includes a plurality of grippers 26 and feed drum 16 rotates grippers 26 into a gripping position with respect to the separated signature 24. When signature 24 is positioned by sucker arm 21, gripper 26 grips the separated signature 24 whereby further rotation of feed drum 16 delivers the separated signature 24 to conveyer 12. Grippers 26 are configured to release signature 24 when signature 24 is in a position to be deposited onto conveyor 12.

As shown in FIG. 2, chain 11 of conveyor 12 typically includes a plurality of conveyor pusher pins or posts 23. Conveyor pusher pins 23 are mounted to chain 11 whereby pins 23 move with chain 11. According to the known art, pins 23 are typically used as guides for receiving signatures 24 on conveyor 12 and conveying signatures 24 along conveyor 12, for example, in the direction of arrow 25. According to the known art, as shown in FIG. 2, at least some separation δ may be provided between the trailing edge 27 and each pin 23. In some applications separation δ may be essentially zero whereby signatures 24 may substantially abut pins 23. However, in other applications, for example, where multiple signatures are stacked between pins 23, separation δ may be non-zero, for example, δ may be about ½ inch or more.

According to aspects of the present invention, providing a consistent separation δ between each pin 23 and the trailing edge 27 of signature 24 can be critical to providing a consistent, uniform signature or stack of signatures 24 to the downstream handling equipment. For example, as shown by reference number 28 in FIG. 2, should the separation δ vary during the placement of signatures 24 upon previously placed signatures, for example, by an amount Δ, the alignment of the signatures 24 on conveyor 12 may vary whereby one or more signatures may extend beyond other signatures, as indicated at reference number 30 in FIG. 2. Such misalignments, or “long books”(as such misalignments are referred to when binding) or “long packages”(as such misalignments are referred to when collating), are undesirable. For example, when conveyor 12 is handling signatures that are to be bound together, for example, into a book or magazine, long books interfere with the uniformity of the bound copy. Also, when conveyor 12 is handling, for example, FSIs that are to be collated, long packages interfere with the package sealing process by getting in between, for example, two thicknesses of polywrap whereby the polywrap cannot be effectively sealed. Misaligned signatures, such as, long books and long packages, are typically scrapped or recirculated, typically manually, for example, back to the hopper 18 in feeder 14. Such misalignments are typically minimized by the proper timing of the speed of the chain 11 and the speed of the feeder drum 16. However, another source of misalignment of signatures 24 cannot be addressed by servomotor timing adjustments alone.

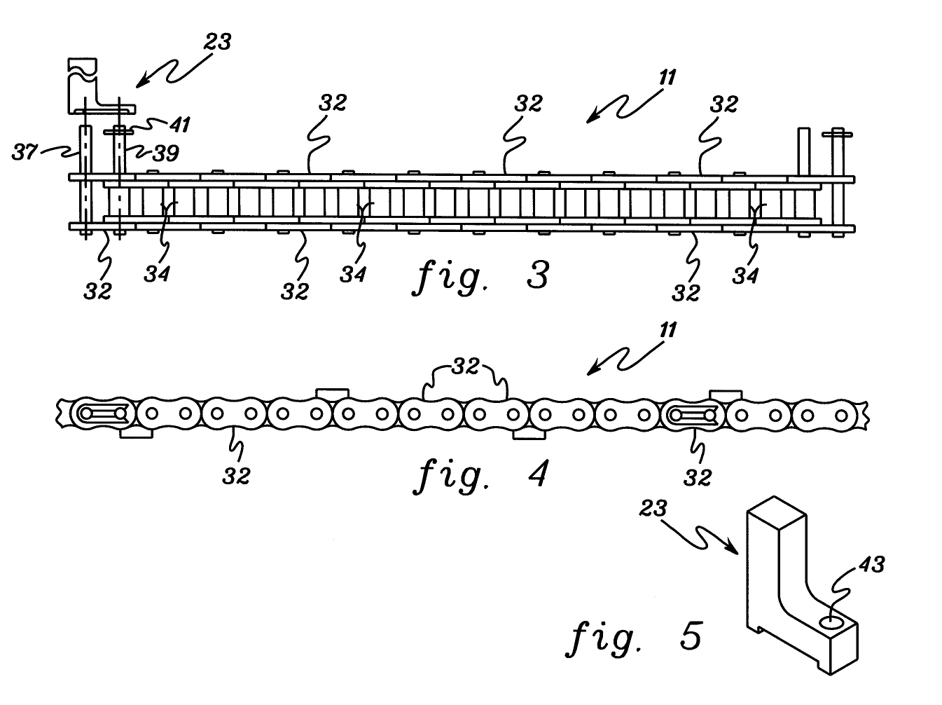

Signature collation misalignment can also be caused by variations in the length of chain 11. With reference to FIG. 1, as chain 11 is driven by motor 13 and translates around sprockets 15, 17, and others, the length of chain 11 may vary. This variation in chain length, or “chain stretch,” whereby the nominal length of chain 11 varies, can be caused by wear or deflection of the chain elements or in deflection of the motor drive sprocket or idler sprockets. FIG. 3 is a plan view of a typical section of drive chain 11 according to one aspect of the invention. FIG. 4 is an elevation view of the section of drive chain 11 shown in FIG. 3. As shown in FIGS. 3 and 4, chain 11 may typically be comprised of a series of links 32 and bushings 34. As also shown, chain 11 includes a plurality of pusher pins 23 mounted to chain 11. FIG. 5 is a perspective view of a pusher pin 23 that can be mounted to the conveyor chain 11 shown in shown in FIGS. 3 and 4. Pusher pin 23 may be mounted to chain 11 by conventional means, for example, by mechanical fasteners, such as pins 37, 39 and snap ring 41. As shown in FIG. 5, pusher pins 23 may include one or more holes 43 adapted to accept pins 37 or 39.

Links 32 and bushings 34 may be subject to varying loading as chain 11 traverses conveyor 12 and, due to deformation and/or wear, the distance between successive pusher pins 23 may vary. Chain stretch may be particularly acute as the length of conveyor 12 increases and chain 11 becomes longer. For example, in some conventional conveyors 12, chain 11 may be 500 or 600 feet in length since chain 11 must traverse conveyor 12 and then return.

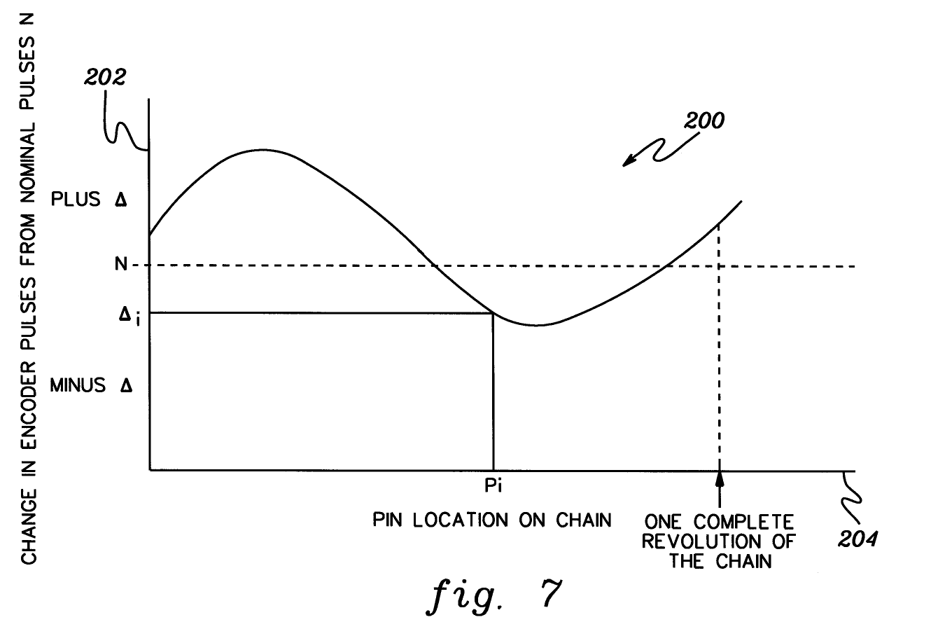

The inventor has found that the magnitude of chain stretch, that is, Δ, is typically not consistent or uniform and may vary significantly during the translation of chain 11. For example, change in chain local chain length caused by chain stretch at any one pusher pin may be as much as 2½ to 3 inches or more. Furthermore, contrary to what is suggested by the prior art, variation in chain stretch is typically not linear. As indicated in FIG. 7 below, variation in chain stretch can vary non-uniformly along the length of chain 11 whereby the localized stretch, that is, the Δ associated with a given pusher pin 23, may vary continuously, for example, for a plurality of pins 23, or even for each pin 23.

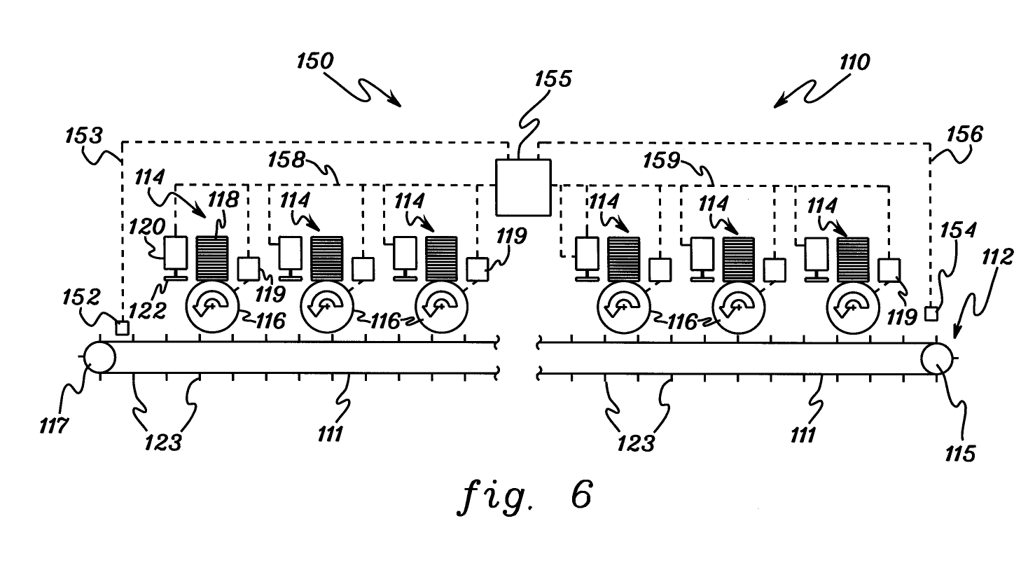

Aspects of the present invention address this variation in chain length to minimize misalignment of signatures 24 on conveyor 12. According to aspects of the present invention, chain stretch is monitored and the feeding of signatures 24 to conveyor 12 is regulated to minimize or prevent variations in separation δ. One aspect of the invention is illustrated in FIG. 6.

FIG. 6 is a schematic illustration of a conveyor system 110 that is adapted to regulate the operation of the chain driven conveyor 10 shown in FIG. 1. Similar to system 10 shown in FIG. 1, conveyor system 110 includes a series of feeders 114 having a rotatable feed drum 116, stacked signatures 118, and a separator disk 122 driven by servomotor 220 for feeding individual signatures to a conveyor 112, though aspects of the invention may apply to any conventional feeding device. As in feeder 14, feed drum 116 is driven by a servomotor that is schematically illustrated by box 119 in FIG. 6. As is typical of the art, feeder 114 is adapted to feed individual signatures to conveyor 112 that includes at least one chain 111 having a plurality of pins 123. Chain 111 is shown schematically in FIG. 6 as mounted on representative sprockets 115 and 117, but the actual chain drive may be similar to that shown for chain 11 in FIG. 1. Chain 111 and pins 123 may be similar to chain 11 and pins 23 shown in FIGS. 3, 4, and 5.

According to aspects of the invention, system 110 includes a control system 150 adapted to monitor chain stretch and regulate the operation of separator disk 122 and/or feed drum 116 to minimize or prevent misalignments in the placement of individual signatures on conveyor 112. Control system 150 includes a least one position sensor 152, but typically a plurality of position sensors 152 and 154, adapted to sense the presence of a structure mounted on chain 111. Sensors 152, 154 may comprise sensors adapted to detect the profile of chain 111; may comprise proximity sensors, such as, magnetic sensors; or may comprise rotary encoders, that is, digital electronic devices used to convert the angular position of a shaft or axle to a digital code. The structure on chain 111 detected by sensors 152 and 154 may typically be the pins 123 mounted on chain 111, though other structures or similar detectable features may be sensed by sensors 152 and 154. According to aspects of the present invention, the one or more sensors 152 and 154 are adapted to transmit a signal to a control unit 155 via electrical connections 153 and 156. The control unit 155 may be, for example, a computer, programmable logic controller (PLC), or a similar device that may be adapted to receive, store, and manipulate the signals received from sensors 152 and 154, and transmit a control signal to one or more servomotors 119 and/or 120 over electrical connections 158 and/or 159 to regulate the operation of disk feeder 122 and/or drum feeder 116. In one aspect of the invention, 3 or more sensors 152, 154 may be provided.

Sensors 152, 154 may be position sensors adapted to detect the presence of pins 123 or other detectable structures and transmit an electrical signal to control unit 155, for example, a 4 to 20 mA signal or a 0 to 24 VDC signal. In one aspect, sensors 152 and 154 may be photoelectric “eyes” adapted to sense the presence of pins 123 and output an appropriate electrical signal to control unit 155.

In one aspect of the invention, sensors 152 and 154 may be encoders adapted to count the number of pulses between a plurality of successive pins 123. For example, for a given chain length, number of pins 123, and separation between of pins 123 on chain 111, the nominal number of encoder pulses counted between pins 123 may be N. In one aspect, any difference from the nominal pulses N may be Δ pulses, whereby the value of Δ may vary due to chain stretch as the chain 111 translates about conveyor 112. FIG. 7 illustrates a typical profile 200 of the value of Δ for one rotation of chain 111 about conveyor 112. In FIG. 6, the ordinate 202 of profile 200 comprises the number of pulses Δ that vary from the nominal number of pulses N for a given chain 111 and pin 123 spacing. As shown in FIG. 6, the deviation Δ may be positive or negative, that is, greater or less than the nominal pulses N. The abscissa 204 of profile 200 comprises the locations of pins 123 on chain 111. In one aspect, the sensors 152 and 154 may be adapted to count the number of pulses between each of the successive pins 123.

Typically, profile 200 may be determined for one complete revolution of chain 111, as shown in FIG. 7, or profile 200 may comprise a time average composite profile for a plurality of revolutions of chain 111, for example, 2, 3, or more revolutions of chain 111. In addition, profile 200 is representative of a typical chain stretch characteristic, for example, representing a smooth curve. Actual chain stretch profiles may be less uniform and reflect the signal noise or electrical interference that can typical of industrial applications.

According to aspects of the invention, the profile 200 shown in FIG. 7 may be used as a basis for varying the rate at which signatures are transferred to conveyor 112. For example, when Δ is positive, implying that separation δ between pin 23, 123 and the trailing edge 27 (see FIG. 2) of signature 24, 124 is greater than desired, the speed of delivery of signature 124 by feeder 114 may be delayed to minimize variation from the desired value of δ (for example, ½ inch). The delay in the delivery of signature 124 to conveyor 112 may be provided by regulating the speed of disk separator 122, regulating the speed of drum feeder 116, or both for the pin 123 related to deviation Δ. Conversely, when Δ is negative, implying that separation δ between pin 23, 123 and the trailing edge 27 (see FIG. 2) of signature 24, 124 is less than desired, the speed of delivery of signature 124 by feeder 114 may be increased to minimize variation from the desired value of δ. Again, the increase in the speed of delivery of signature 124 to conveyor 112 may be provided by regulating the speed of disk feeder 122, drum feeder 116, or both for the pin 123 related to deviation Δ.

According to one aspect, the profile 200 shown in FIG. 6 may be stored in processing unit 155 and used as a basis for controlling the operation of servomotors 117 and/or 120. Profile 200 may be updated continuously or intermittently, for example, at regular intervals, for instance, every 15 minutes or once a day, depending upon the time variation of profile 200. In another aspect of the invention, profile 200 may be associated with a specific chain, a specific collating process, or a specific medium, for example, newsprint or book signatures, and stored for re-use when needed. That is, different media or collating procedures may have different profiles 200 that can be stored and recalled to operate system 110 as needed.

According to aspects of the present invention, the invention may be practiced by first monitoring chain stretch by means of sensors 152 and 154 during operation of conveyor 112, for example, prior to activating feeders 114, to determine and record a chain stretch profile 200 in control unit 155, as shown in FIG. 7. As shown in FIG. 7, each pusher pin 123 (designated pᵢ in FIG. 7) is associated with a localized chain stretch Δᵢ. Having profile 200 stored in control unit 155, feeders 114 of conveying system 110 can be activated to deliver signatures to conveyor 112. However, with the aid of the profile 200 stored in control unit 155, the speed of disk separator 122 or the speed of drum feeder 116, or both are regulated by control unit 155 according to profile 200. For example, when pin pᵢ having a predetermined localized chain stretch Δᵢ encounters a specific feeder 14, 114, the control unit 155 may vary the speed of servomotor 119, 120, or both to compensate for the chain stretch Δᵢ. For instance, when Δᵢ is positive (implying that separation δ between pin 123 and the trailing edge 27 (see FIG. 2) of signature 124 is greater than desired), the speed of delivery of signature 124 by drum feeder 116 or disk 122 (or a different type feeder) may be delayed to minimize variation from the desired value of δ. Conversely, when Δᵢ is negative (implying that separation δ between pin 123 trailing edge 27 of signature 124 is less than desired), the speed of delivery of signature 124 by drum feeder 116 or disk 122 may be increased to minimize variation from the desired value of δ. As a result, aspects of the present invention provide for increased uniformity in delivery and stacking of signatures whereby a uniform product is delivered to the downstream handling, for example, binding, packaging, or other processing.

Aspects of the present invention provide systems, methods, and apparatus that overcome the problems associated with chain stretch in conveying systems having chain-driven conveyors. The detection of the continuous variation in chain stretch during the handling of sheet material can be used to regulate the feeding of sheet material to a chain-driven conveyor to minimize or prevent misfeeding and misalignment that typically characterizes such devices to provide improved throughput with lower defects and decreased handling of defects.

While several aspects of the present invention have been described and depicted herein, alternative aspects may be effected by those skilled in the art to accomplish the same objectives. Accordingly, it is intended by the appended claims to cover all such alternative aspects as fall within the true spirit and scope of the invention.

1. A method for feeding signatures to a chain conveyor, the chain conveyor having a chain and a plurality of indexing pins mounted to the chain, the method comprising:
activating the chain conveyor;
transferring the signatures to the chain conveyor wherein each signature is spaced from at least one of the indexing pins on the chain conveyor;
detecting a variation in chain length for a plurality of the indexing pins of the chain conveyor; and
controlling the transfer of signatures to the chain conveyor in response to the variations in chain length to minimize variations in the spacing of the signatures and the indexing pins.

2. The method as recited in claim 1, wherein transferring the signatures to the chain conveyor is practiced using a signature feeder adapted to transfer signatures from a supply of signatures to the chain conveyor, the signature feeder having a variable speed motor adapted to provide the motive force to transfer the signatures to the chain conveyor, and wherein controlling the transfer of signatures to the chain conveyor comprises controlling the speed of the variable speed motor.

3. The method as recited in claim 1, wherein transferring the signatures to the chain conveyor is practiced using a disk separator adapted to transfer signatures from a supply of signatures and a drum conveyor adapted to receive signatures from the disk separator and transfer the signatures to the chain conveyor, and wherein controlling the transfer of signatures to the chain conveyor comprises controlling the operation of at least one of the disk conveyor and the drum conveyor.

4. The method as recited in claim 3, wherein at least one of the disk conveyor and the drum conveyor is driven by a variable speed motor, and wherein controlling the transfer of signatures to the chain conveyor comprises controlling a speed of the variable speed motor.

5. The method as recited in claim 1, wherein transferring the signatures to the chain conveyor is practiced using a crank conveyor adapted to transfer signatures from a supply of signatures to the chain conveyor, and wherein controlling the transfer of signatures to the chain conveyor comprises controlling the operation of the crank conveyor.

6. The method as recited in claim 5, wherein the crank conveyor is driven by a variable speed motor, and wherein controlling the transfer of signatures to the chain conveyor comprises controlling a speed of the variable speed motor.

7. The method as recited in claim 1, wherein detecting a variation in chain length comprises providing at least one sensor adapted to detect the variation in chain length.

8. The method as recited in claim 7, wherein providing at least one sensor comprises providing a plurality of spaced sensors.

9. The method as recited in claim 8, wherein the plurality of spaced sensors comprise a plurality of sensors adapted to detect the indexing pins.

10. The method as recited in claim 8, wherein the plurality of sensors is adapted to detect duration between detection of successive indexing pins.

11. The method as recited in claim 1, wherein detecting a variation in chain length for a plurality of the indexing pins comprises detecting a variation in chain length for each of the indexing pins.

12. The method as recited in claim 1, wherein the method further comprises recording the variation in chain length for each of the indexing pins to provide a plurality of recorded variations and wherein controlling the transfer of signatures comprises controlling the transfer of signatures in response to the plurality of recorded variations in chain length.

13. A system for feeding signatures to a chain conveyor having a chain and a plurality of indexing pins mounted to the chain, the system comprising:
a signature feeder adapted to transfer signatures from a supply of signatures to the chain conveyor, the signature feeder having at least one variable speed motor adapted to provide the motive force to transfer the signatures to the chain conveyor;
at least one sensor adapted to detect a variation in chain length for a plurality of the indexing pins of the chain conveyor; and
a controller adapted to control the at least one variable speed motor in response to the variation in chain length to minimize variations in the spacing of the signatures and the indexing pins.

14. The system as recited in claim 13, wherein the signature feeder comprises
a disk separator adapted to transfer signatures from a supply of signatures; and
a drum conveyor adapted to receive signatures from the disk separator and transfer the signatures to the chain conveyor.

15. The system as recited in claim 14, wherein the at least one variable speed drive is adapted to drive at least one of the disk separator and the drum conveyor.

16. The system as recited in claim 13, wherein the signature feeder comprises a crank feeder.

17. The system as recited in claim 16, wherein the at least one variable speed drive is adapted to drive the crank feeder.

18. The system as recited in claim 13, wherein the at least one variable speed drive comprises at least one servomotor.

19. The system as recited in claim 13, wherein the at least one sensor comprises a plurality of spaced sensors.

20. The system as recited in claim 19, wherein the plurality of spaced sensors comprise a plurality of sensors adapted to detect the indexing pins.

21. The system as recited in claim 13, wherein the at least one sensor adapted to detect a variation in chain length for a plurality of the indexing pins comprises at least one sensor adapted to detect a variation in chain length for each of the indexing pins.

22. The system as recited in claim 21, wherein the controller is adapted to control the at least one variable speed motor in response to the duration between successive indexing pins.

23. The system as recited in claim 13, wherein the system further comprises a storage device adapted to store a plurality of variations in chain length and wherein the controller is adapted to control the at least one variable speed motor in response to the plurality of stored variations in chain length.

24. A system for assembling signatures comprising:
a collator having a chain conveyor, the chain conveyor having a chain and a plurality of indexing pins mounted to the chain;
a disk separator adapted to transfer signatures from a supply of signatures;
a drum conveyor adapted to receive signatures from the disk separator and transfer the signatures to the collator wherein each signature is spaced from at least one of the indexing pins;
at least one variable speed motor adapted to rotate at least one of the disk separator and the drum conveyor;
at least one sensor adapted to detect a variation in chain length for a plurality of the indexing pins of the chain conveyor; and
a controller adapted to regulate operation of the at least one variable speed motor to vary speed of at least one of the disk separator and the drum conveyor in response to the variation in chain length to minimize misalignment of signature placement relative to the indexing pins.

25. The system as recited in claim 24, wherein the at least one sensor comprises a plurality of spaced sensors.

26. The system as recited in claim 25, wherein the plurality of spaced sensors comprise a plurality of sensors adapted to detect the indexing pins.

27. The system as recited in claim 25, wherein the at least one sensor adapted to detect a variation in chain length for a plurality of the indexing pins comprises at least one sensor adapted to detect a variation in chain length for each of the indexing pins.

28. The system as recited in claim 24, wherein the system further comprise a storage device adapted to store a plurality of variations in chain length, and wherein the controller is adapted to control the operation of at least one of the disk separator and the drum conveyor in response to the plurality of stored variations in chain length.
